(19) United States
(12) Patent Application Publication
(10) Pub. No.: US 2021/0298335 A1
(43) Pub. Date: Sep. 30, 2021

(54) METHOD FOR PRODUCING DEEP-FRIED FOOD

(71) Applicant: NICHIREI FOODS INC., Tokyo (JP)

(72) Inventors: Satoru KAKIZAKI, Chiba-shi (JP); Masashi AKUTAGAWA, Chiba-shi (JP); Fumiko SUEMASA, Chiba-shi (JP); Yosuke MIYAHARA, Chiba-shi (JP)

(73) Assignee: NICHIREI FOODS INC., Tokyo (JP)

(21) Appl. No.: 17/264,753

(22) PCT Filed: Aug. 1, 2019
(86) PCT No.: PCT/JP2019/030223

§ 371 Date: Jan. 29, 2021

(30) Foreign Application Priority Data
Aug. 1, 2018 (JP) 2018-145465
Nov. 16, 2018 (JP) 2018-215970

(51) Int. Cl. A23L 5/10; A23L 13/50; A47J 37/12

(52) U.S. Cl. CPC A23L 5/11; A23V 2002/00; A47J 37/1276; A23L 13/57

(57) ABSTRACT

The present disclosure relates to a method for producing a deep-fried food. More specifically, the present disclosure relates to a method for producing a deep-fried food, comprising: a first step of deep-frying a food material to obtain a first deep-fried material, and tempering the first deep-fried material in a state of being taken out from an oil; a second step of deep-frying the first deep-fried material to obtain a second deep-fried material, and tempering the second deep-fried material in a state of being taken out from an oil; and a third step of deep-frying the second deep-fried material to obtain a deep-fried food from an oil, wherein a mass proportion of the deep-fried food to the food material is 85% or more.

### CROSS-REFERENCE TO RELATED APPLICATION

The present application is based on and claims the benefit of priority from earlier Japanese Patent Application No, 2018-145465 filed on Aug. 1, 2018 and Japanese Patent Application No, 2018-215970 filed on Nov. 16, 2018, the entire disclosures of which are incorporated herein by reference.

### TECHNICAL FIELD

The present disclosure relates to a method for producing a deep-fried food.

### BACKGROUND ART

Conventionally, various techniques for improving the quality of deep-fried products have been studied in the industrial production of deep-fried products of livestock and marine foods. For example, the use of a water retaining agent and the addition of water by immersion, massaging, injection or the like are generally performed in order to improve a yield.

Patent Literature 1 discloses a method for producing a fried food, comprising starting frying of a material to be fried, which has been coated by a conventional method, at an oil temperature of 150° C. to 200° C.; reducing the oil temperature while continuing the frying for 5 minutes to 15 minutes; and terminating the frying at an oil temperature of 100° C. to 150° C., wherein microwave heating is employed in combination for the frying.

Patent Literature 2 discloses a method for producing a fried food, comprising shaping a salted fish meat paste and heating the shaped product in oils in two steps, wherein, after the heating in an oil in a first step, the fried food is treated in an oil having a temperature lower than the heating temperature in the first step so as to almost uniformize the surface temperature of the fried food and its central temperature, and is then subjected to heating in a second step.

### CITATION LIST

### Patent Literatures

Patent Literature 1: JP H6-125721 A

Patent Literature 2: JP H10-28558 A

### SUMMARY OF INVENTION

The present disclosers have now found that, when specific three-step deep-frying treatment is applied to a food material, a yield in a deep-fried food can be remarkably improved.

The present disclosure provides a method for producing a deep-fried food with a remarkably improved yield.

The present disclosure encompasses the following (1) to (15).

(1) A method for producing a deep-fried food, comprising:

a first step of deep-frying a food material to obtain a first deep-fried material, and tempering the first deep-fried material in a state of being taken out from an oil;

a second step of deep-frying the first deep-fried material to obtain a second deep-fried material, and tempering the second deep-fried material in a state of being taken out from an oil; and

a third step of deep-frying the second deep-fried material to obtain a deep-fried food from an oil,

wherein a mass proportion of the deep-fried food to the food material is 85% or more.

(2) A method for reducing the amount of an oil to be absorbed by a food material in the production of a deep-fried food, comprising:

a first step of deep-frying a food material to obtain a first deep-fried material, and tempering the first deep-fried material in a state of being taken out from an oil;

a second step of deep-frying the first deep-fried material to obtain a second deep-fried material, and tempering the second deep-fried material in a state of being taken out from an oil; and

a third step of deep-frying the second deep-fried material to obtain a deep-fried food from an oil.

(3) The method according to (1) or (2), wherein the food material comprises a livestock or marine product, a vegetable, or a processed product thereof.

(4) The method according to any of (1) to (3), wherein the deep-frying in the first step is performed at a low, medium or high temperature.

(5) The method according to any of (1) to (4), wherein the deep-frying time in the first step is 30 seconds or more and 3 minutes or less.

(6) The method according to any of (1) to (5), wherein the tempering in the first step is performed at an ordinary temperature.

(7) The method according to any of (1) to (6), wherein the tempering time in the first step is 30 seconds or more and 5 minutes or less.

(8) The method according to any of (1) to (7), wherein the deep-frying in the second step is performed at a low, medium or high temperature.

(9) The method according to any of (1) to (8), wherein the deep-frying time in the second step is 30 seconds or more and 3 minutes or less.

(10) The method according to any of (1) to (9), wherein the tempering in the second step is performed at an ordinary temperature.

(11) The method according to any of (1) to (10), wherein the tempering time in the second step is 30 seconds or more and 5 minutes or less.

(12) The method according to any of (1) to (11), wherein the deep-frying in the third step is performed at a medium or high temperature.

(13) The method according to any of (1) to (12), wherein the deep-frying time in the third step is 30 seconds or more and 3 minutes or less.

(14) The method according to any of (1) to (13), wherein the time ranging from the beginning of the deep-frying in the first step to the obtainment of the deep-fried food in the third step is 5 minutes or more and 15 minutes or less.

(15) A deep-fried food obtained by the method according to any of (1) to (14).

(16) A method for improving a yield in a deep-fried food, comprising:

a first step of deep-frying a food material to obtain a first deep-fried material, and tempering the first deep-fried material in a state of being taken out from an oil;

a second step of deep-frying the first deep-fried material to obtain a second deep-fried material, and tempering the second deep-fried material in a state of being taken out from an oil; and

a third step of deep-frying the second deep-fried material to obtain a deep-fried food from an oil,

wherein a yield calculated as a mass proportion of the deep-fried food to the food material is 85% or more.

(17) The method according to (18), which suppresses deterioration of an oil in the production of a deep-fried food with an improved yield.

(18) An apparatus for producing a deep-fried food, comprising:

a first deep-frying unit for deep-frying a food material to obtain a first deep-fried material;

a second deep-frying unit for deep-frying the first deep-fried material to obtain a second deep-fried material;

a third deep-frying unit for deep-frying the second deep-fried material to obtain a deep-fried food;

a first conveying unit for conveying the first deep-fried material taken out from the first deep-frying unit to the second deep-frying unit while tempering it; and

a second conveying unit for conveying the second deep-fried material taken out from the second deep-frying unit to the third deep-frying unit while tempering it.

The present disclosure can remarkably improve the yield in the deep-fried food. The present disclosure can reduce the amount of the oil to be absorbed in the deep-fried food. Also, the present disclosure can greatly save the amount of the oil to be used in the production of the deep-fried food. Further, the present disclosure can suppress the oxidative deterioration of the oil in the production of the deep-fried food.

### BRIEF DESCRIPTION OF DRAWINGS

FIG. 1 is a photograph showing a cross section of a fried meat corresponding to Score 1 of red meat in Test Example 1.

FIG. 2 is a photograph showing a cross section of a fried meat corresponding to Score 5 of red meat in Test Example 1,

FIG. 3 is a schematic diagram showing an apparatus according to one embodiment of the present disclosure.

FIG. 4 is a graph showing the relationship between the total throughput (kg) of a sample and the amount (kg) of an oil absorbed thereby in Test Section 22 in Test Example 2 and Reference Example 2.

FIG. 5 is a graph showing the amount (kg) of moisture contained in an ingredient of each of samples in Test Sections 23A to 23C in Test Example 3 and Reference Examples 3A to 3C.

FIG. 6 is a graph showing the amount (kg) of an oil absorbed in a coating of each of the samples in Test Sections 23A to 23C in Test Example 3 and Reference Examples 3A to 3C.

FIG. 7 is a graph showing the transition of an AV value of an oil in each of first to third deep-frying units of Test Section 24 in Test Example 4 and first and second deep-frying units of Reference Example 4.

### DETAILED DESCRIPTION OF THE INVENTION

The “low temperature” as used herein means a temperature of 130° C. or higher and lower than 150° C.

The “medium temperature” as used herein means a temperature of 150° C. or higher and lower than 160° C.

The “high temperature” as used herein means a temperature of 160° C. or higher.

One embodiment of the present disclosure provides a method for producing a deep-fried food, comprising:

a first step of deep-frying a food material to obtain a first deep-fried material, and tempering the first deep-fried material in a state of being taken out from an oil;

a second step of deep-frying the first deep-fried material to obtain a second deep-fried material, and tempering the second deep-fried material in a state of being taken out from an oil; and

a third step of deep-frying the second deep-fried material to obtain a deep-fried food from an oil,

wherein a mass proportion of the deep-fried food to the food material is 85% or more. The method of the present disclosure can advantageously be utilized in remarkably improving the yield in the deep-fried food and giving a juicy texture.

Another embodiment of the present disclosure provides a method for reducing the amount of an oil to be absorbed by a food material in the production of a deep-fried food, comprising:

a first step of deep-frying a food material to obtain a first deep-fried material, and tempering the first deep-fried material in a state of being taken out from an oil;

a second step of deep-frying the first deep-fried material to obtain a second deep-fried material, and tempering the second deep-fried material in a state of being taken out from an oil; and

a third step of deep-frying the second deep-fried material to obtain a deep-fried food from an oil. The method of the present disclosure can advantageously be utilized in that the method can reduce the amount of the oil to be absorbed by the food material, as compared with a method for producing a deep-fried food involving a deep-frying step which is different from that in the method of the present disclosure, such as so-called twice frying or once frying, and can suppress the intake of the oil in a person who eats the deep-fried food. Also, the method can advantageously be utilized in that the method can suppress the amount of the frying oil to be consumed in the production of the deep-fried food.

### First Step

To produce a deep-fried food of the present disclosure, first, there is carried out a first step of deep-frying a food material to obtain a first deep-fried material, and tempering the first deep-fried material in a state of being taken out from an oil.

The food material used in the present disclosure is not particularly limited, but is preferably a livestock or marine product, a vegetable, or a processed product thereof, more preferably a meat, a fish or a crustacean (preferably, shrimp, crab or the like), a vegetable, or a processed product thereof, further preferably a meat such as beef, pork, chicken or mutton, a fish, shrimp, a vegetable, or a processed product thereof. Suitable examples of the processed product include slices, pastes and crushed products.

According to one embodiment of the present disclosure, a blood-containing food material (preferably, a meat, a fish, or a processed product thereof) is preferably used. The use of such a food material in the method of the present disclosure is advantageous in promoting browning of blood contained in the food material to prevent red meat having a blood color from remaining.

According to one embodiment of the present disclosure, the food material may be processed by battering, flouring, and/or coating. In other words, the food material of the present disclosure encompasses those having a coating portion. The conditions for battering or coating of the food material in the present disclosure are not particularly limited, and can appropriately be selected by those skilled in the art.

According to one embodiment of the present disclosure, the upper limit of a central temperature of the food material before the deep-frying in the first step is not particularly limited and may be set to 25° C., but, from the viewpoint of hygiene maintenance of the food material, is preferably 15° C., more preferably 10° C., further preferably 8° C. The lower limit of the central temperature of the food material before the deep-frying is not particularly limited, and can be set, for example, to −5° C. Note that the central temperature in the present disclosure is a temperature of a central portion, which is most hardly heated, of the food material to be deep-fried. For example, when the food material in fried chicken is a rectangular parallelepiped-shaped chicken meat, the central temperature is a temperature of a portion where diagonal lines cross each other. The central temperature can be measured by inserting a stick-shaped thermometer into the center of the food material, as described in Test Example 1 which will be presented below.

According to one embodiment of the present disclosure, a mass of the food material is not particularly limited, but is preferably 10 g or more and 200 g or less, more preferably 15 g or more and 150 g or less, further preferably 20 g or more and 150 g or less, still further preferably 20 g or more and 50 g or less, even still further preferably 20 g or more and 45 g or less.

The deep-frying temperature in the first step is not particularly limited, but is preferably a low, medium or high temperature. From the viewpoint of hardening the surface of the food material to prevent outflow of moisture, the deep-frying temperature in the first step is preferably a medium or high temperature, more preferably 150° C. or higher and 180° C. or lower, further preferably 150° C. or higher and 170° C. or lower. Especially when the deep-fried material of the present disclosure is a frozen food which is a food for microwave oven cooking assumed to be microwave-heated before eating, it is preferable to finish the deep-fried material so that the food surface has a crispy texture, and thus the deep-frying temperature in the third step is preferably a high temperature.

The deep-frying time in the first step is not particularly limited, but is preferably 30 seconds or more and 3 minutes or less, more preferably 35 seconds or more and 1 minute 30 seconds or less, further preferably 35 seconds or more and 1 minute 20 seconds or less.

The central temperature of the first deep-fried material after the deep-frying in the first step is not particularly limited, but is preferably higher than that of the food material, and, specifically, can be set to 15° C. or higher and 50° C. or lower, but is preferably 20° C. or higher and 50° C. or lower, more preferably 20° C. or higher and 48° C. or lower, further preferably 21° C. or higher and 47° C. or lower.

According to one embodiment of the present disclosure, the deep-fried material is tempered preferably by obtaining the deep-fried material from an oil and retaining the product as it is under normal pressure, without actively cooling the deep-fried material or placing it under pressure/reduced pressure.

According to one embodiment of the present disclosure, the temperature when the first deep-fried material is tempered in the first step is preferably an ordinary temperature. Also, according to another embodiment of the present disclosure, the temperature when the first deep-fried material is tempered in the first step may be set to 10° C. or higher and 30° C. or lower, and is preferably 15° C. or higher and 30° C. or lower, more preferably 15° C. or higher and 25° C. or lower.

The tempering time in the first step can appropriately be set in consideration of the size and shape of the food material, easiness of heat transmission of the raw material, and the like, but, from the viewpoint of utilizing residual heat for efficient heating, is preferably set so that the central temperature of the first deep-fried material rises also during the tempering. The optimum tempering time in the first step is preferably set to a time required when the rise in central temperature of the first deep-fried material in the tempering period arrives at the maximum point. More specifically, the tempering time in the first step of the present disclosure is not particularly limited, and may be set, for example, to 30 seconds or more and 5 minutes or less, but is preferably 30 seconds or more and 3 minutes or less, more preferably 1 minute or more and 3 minutes or less, further preferably 1 minute 20 seconds or more and 2 minutes 20 seconds or less.

The central temperature of the first deep-fried material after the tempering in the first step is not particularly limited, but is preferably 30° C. or higher and 60° C. or lower, more preferably 35° C. or higher and 55° C. or lower, further preferably 38° C. or higher and 53° C. or lower.

### Second Step

In the method for producing a deep-fried food of the present disclosure, the first deep-fried material after the tempering is further deep-fried, and the resultant second deep-fried material is obtained from the oil and subjected to second tempering treatment.

The deep-frying temperature in the second step is not particularly limited, but is preferably a low, medium or high temperature, more preferably 130° C. or higher and 180° C. or lower, further preferably 130° C. or higher and 170° C. or lower.

The deep-frying time in the second step is preferably adjusted according to the deep-frying temperature in the second step, and is more preferably adjusted to be shorter when the deep-frying temperature is increased and to be longer when the deep-frying temperature is decreased. According to one embodiment of the present disclosure, the deep-frying time in the second step is not particularly limited, and may be set, for example, to 30 seconds or more and 3 minutes or less, but is preferably 30 seconds or more and 2 minutes 30 seconds or less, more preferably 45 seconds or more and 2 minutes or less, further preferably 48 seconds or more and 1 minute 55 seconds or less.

The central temperature of the second deep-fried material after the deep-frying in the second step is not particularly limited, but is preferably higher than that of the first deep-fried material, and, specifically, can be set to 50° C. or higher and 90° C. or lower, but is preferably 50° C. or higher and 80° C. or lower, more preferably 53° C. or higher and 75° C. or lower.

According to one embodiment of the present disclosure, the temperature when the second deep-fried material is tempered in the second step is preferably an ordinary temperature. Also, according to another embodiment of the present disclosure, the temperature when the second deep-fried material is tempered in the second step may be set to 10° C. or higher and 30° C. or lower, and is preferably 15° C. or higher and 30° C. or lower, more preferably 15° C. or higher and 25° C. or lower.

The tempering time in the second step can appropriately be set in consideration of the size and shape of the food material, easiness of heat transmission of the raw material, and the like, but is preferably set so that the central temperature of the second deep-fried material rises also during the tempering. The optimum tempering time in the second step is preferably set to a time required when the rise in central temperature of the second deep-fried material in the tempering period arrives at the maximum point. More specifically, the tempering time in the second step of the present disclosure is not particularly limited, and may be set, for example, to 30 seconds or more and 5 minutes or less, but is more preferably 30 seconds or more and 3 minutes or less, further preferably 1 minute or more and 3 minutes or less, still further preferably 1 minute 20 seconds or more and 2 minutes 20 seconds or less.

The central temperature of the second deep-fried material after the tempering in the second step is not particularly limited, but is preferably 60° C. or higher and 85° C. or lower, more preferably 62° C. or higher and 80° C. or lower, further preferably 65° C. or higher and 80° C. or lower.

### Third Step

In the method for producing a deep-fried food of the present disclosure, the second deep-fried material after the tempering is further deep-fried to obtain a deep-fried food.

The deep-frying temperature in the third step is not particularly limited, but is preferably a medium or high temperature, more preferably 150° C. or higher and 180° C. or lower, further preferably 150° C. or higher and 170° C. or lower.

The deep-frying time in the third step is not particularly limited, but is preferably 30 seconds or more and 3 minutes or less, more preferably 35 seconds or more and 1 minute 50 seconds or less, further preferably 38 seconds or more and 1 minute 40 seconds or less.

The method of the present disclosure can efficiently rise the central temperatures of the food material and the deep-fried materials through the use of residual heat applied by the deep-frying, though not using any oil during tempering. Further, the method of the present disclosure can shorten the time for heating the food in the oil, thereby making it possible to efficiently prevent mixing of a food-derived substance into the oil or oxidation of the oil caused by heating. Thus, the method of the present disclosure can especially advantageously be utilized in preventing deterioration of the oil.

According to one embodiment of the present disclosure, the total of the deep-frying times in the first, second and third steps is not particularly limited, but is preferably 2 minutes or more and 5 minutes or less, more preferably 2 minutes 40 seconds or more and 4 minutes 30 seconds or less, further preferably 2 minutes 20 seconds or more and 4 minutes 10 seconds or less.

According to one embodiment of the present disclosure, the total of the tempering times in the first and second steps is not particularly limited, but is preferably 2 minutes 30 seconds or more and 6 minutes 30 seconds or less, more preferably 2 minutes 40 seconds or more and 6 minutes 20 seconds or less, further preferably 2 minutes 50 seconds or more and 6 minutes 10 seconds or less. The method of the present disclosure can continue heating by the residual heat of deep-frying while suppressing outflow of moisture from the food material and deep-fried materials into the oil through the use of the tempering period, and thus is especially advantageous in producing a deep-fried food with a good yield.

According to one embodiment of the present disclosure, a proportion expressed as [total of tempering times in first and second steps]/[total of deep-frying times in first, second and third steps] is not particularly limited, but is preferably 0.25 or more and 1.6 or less, more preferably 0.3 or more and 1.6 or less.

Also, according to one embodiment of the present disclosure, the process ranging from the beginning of the deep-frying in the first step to the obtainment of the deep-fried food in the third step can be carried out rapidly. The time ranging from the beginning of the deep-frying in the first step to the obtainment of the deep-fried food in the third step is not particularly limited, but is preferably 5 minutes to 15 minutes, more preferably 6 minutes to 13 minutes, further preferably 7 minutes to 11 minutes.

### Deep-Fried Food

According to one embodiment of the present disclosure, a deep-fried food obtained by the production method described above is provided. In the deep-fried food obtained by the method of the present disclosure, a yield rate, i.e., mass proportion of the deep-fried food to the food material can be maintained at a high level. The yield rate of the deep-fried food is set to 85% or more, but is preferably 85% or more and 105% or less, more preferably 90% or more, further preferably 95% or more. The upper limit of the yield rate is not particularly limited, but, from the viewpoint of retaining moisture initially contained in the food material, is preferably about 100%. Maintaining the yield rate within the above-specified range by adjusting the deep-frying conditions, regardless of whether water is added or a water retaining agent is present, is advantageous in efficiently providing a deep-fried food having a juicy texture.

According to one embodiment of the present disclosure, a mass per piece of the deep-fried food is not particularly limited, but is preferably 8.5 g or more and 170 g or less, more preferably 12.8 g or more and 127.5 g or less, further preferably 17 g or more and 127.5 g or less, still further preferably 17 g or more and 42.5 g or less, even still further preferably 17 g or more and 38.3 g or less.

Specific examples of the deep-fried food of the present disclosure include deep-fried chicken (karaage), croquette, fried meat cakes, chicken cutlet, pork cutlet, shrimp cutlet, fried fish and fried chicken.

The method of the present disclosure can remarkably improve the yield in the deep-fried food, as described above. Thus, according to another embodiment of the present disclosure, there is provided a method for improving a yield in a deep-fried food, comprising: a first step of deep-frying a food material to obtain a first deep-fried material, and tempering the first deep-fried material in a state of being taken out from an oil; a second step of deep-frying the first deep-fried material to obtain a second deep-fried material, and tempering the second deep-fried material in a state of being taken out from an oil; and a third step of deep-frying the second deep-fried material to obtain a deep-fried food from an oil, wherein a yield calculated as a mass proportion of the deep-fried food to the food material is 85% or more.

Further, the method of the present disclosure can shorten the time for heating the food in the oil, and thus is advantageous in efficiently suppressing or preventing mixing of a food-derived substance into the oil or oxidation of the oil caused by heating. Therefore, according to another embodiment of the present disclosure, the method of the present disclosure may be used as a method for suppressing deterioration of an oil in the production of a deep-fried food.

### Apparatus for Producing Deep-Fried Food

The production of a deep-fried product according to the present disclosure can be carried out using a common apparatus. For example, the method of the present disclosure may be carried out using a heating apparatus having one or more oil tank(s) and repeating movement of a material to be deep-fried into/from an oil. Also, in the method of the present disclosure, an apparatus comprising a plurality of oil tanks may be used. An apparatus comprising three oil tanks is preferably used. Thus, according to one embodiment of the present disclosure, there is provided an apparatus for producing a deep-fried food, comprising: a first deep-frying unit for deep-frying a food material to obtain a first deep-fried material; a second deep-frying unit for deep-frying the first deep-fried material to obtain a second deep-fried material; a third deep-frying unit for deep-frying the second deep-fried material to obtain a deep-fried food; a first conveying unit for conveying the first deep-fried material taken out from the first deep-frying unit to the second deep-frying unit while tempering it; and a second conveying unit for conveying the second deep-fried material taken out from the second deep-frying unit to the third deep-frying unit while tempering it.

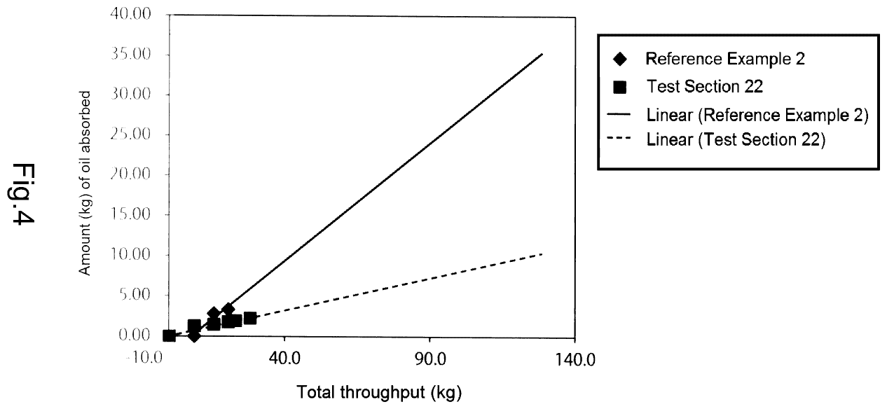

In an apparatus 1 of one embodiment of the present disclosure, a first deep-frying unit 2, a first conveying unit 3, a second deep-frying unit 4, a second conveying unit 5 and a third deep-frying unit 6 may be connected in series, as shown in FIG. 3.

In the apparatus according to one embodiment of the present disclosure, the first, second and third deep-frying units each preferably comprise an oil tank, a heating unit for heating an oil in the oil tank, and an auxiliary unit for taking out the material to be deep-fried from the inside and outside of the oil tank and moving it to each of the conveying units. Examples of such deep-frying units include known apparatuses such as a fryer to which a basket for housing the material to be deep-fried is coupled movably.

In the apparatus according to one embodiment of the present disclosure, the first and second conveying units may be, for example, belt conveyors. When belt conveyors are used, the deep-fried materials can be tempered on the belts during conveyance.

The apparatus according to one embodiment of the present disclosure may comprise one or more sensor(s) that measure(s) the deep-frying temperatures and times in the first, second and third deep-frying units as well as the conveying speeds of the first and second conveying units. Further, the apparatus according to one embodiment of the present disclosure may comprise a control unit that receives information from the sensor(s) and controls the deep-frying temperatures and times in the first, second and third deep-frying units and the conveying speeds of the first and second conveying units. The control unit can control the operations of the first, second and third deep-frying units as well as the first and second conveying units, and also can control the timings for picking up the materials to be deep-fried from the oils, the movement of the materials to be deep-fried from the deep-frying units to the conveying means, the deep-frying temperature and time, and the like. The control unit is composed, for example, of a computer provided with a CPU, a RAM, a ROM and the like, and performs various types of processing for carrying out the method of the present disclosure based on various types of data, various programs and the like stored therein.

### EXAMPLES

Hereinafter, the present invention will be described in detail by way of examples, but the technical scope of the present invention is limited to these examples. Hereinafter, the symbol “%” represents % by mass unless otherwise specified.

### Test Example 1

Chicken meat was battered by a conventional method to obtain a test sample. Then, an oil tank having a capacity enough for the entire obtained test sample to sink was used to carry out deep-frying and tempering under the following conditions (reference test and Test Sections 1 to 20) so as to attain heating strength which satisfied the condition that the central temperature of a deep-fried food was retained at 70° C. for 1 minute or more, and comparison was made in terms of the yield rate (%) in the obtained fried chicken (=mass after all deep-frying steps/mass before first deep-frying step×100), the juicy texture, and the presence of a residual red meat portion (blood-color portion remaining, without browning of blood, in the cut surface when the fried chicken was cut in half). A digital thermometer (TX10 manufactured by Yokogawa Test & Measurement Corporation) was used to measure the central temperature of the test sample after each of the deep-frying and tempering steps. Note that the number of the samples of Reference Example 1 and Test Sections 1 to 6 are 20 (n=20), and the number of the samples of Reference Example 1 and Test Sections 7 to 21 are 8 (n=8). The numerical values in the tables are average values, except that they are indicated as numerical widths.

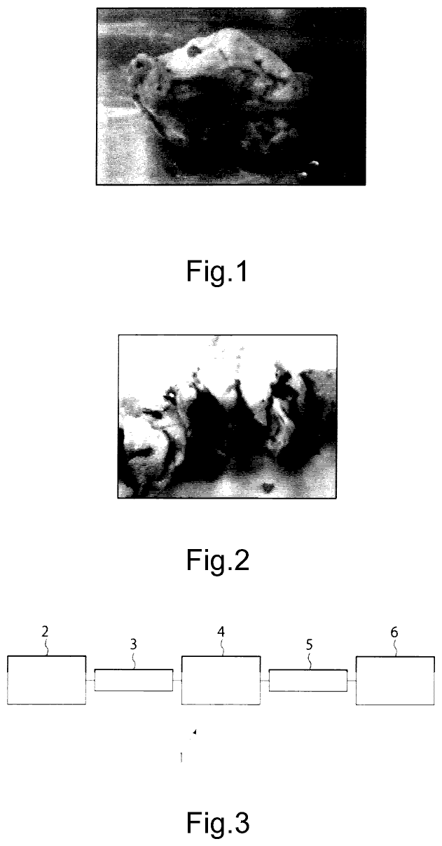

The juicy texture and the presence of a residual red meat portion were evaluated by scores according to the following criteria for determination by 10 trained expert panels. Note that the juicy texture of Reference Example 1 which will be described later, was set as a standard of Score 3. The cross section of the fried meat corresponding to Score 1 of red meat is as shown in the photograph in FIG. 1, and the cross section of the fried meat corresponding to Score 5 of red meat is as shown in the photograph in FIG. 2.

### Juicy Texture

5: Very juicy texture

4: Juicy texture

3: Slight juicy texture

2: Little juicy texture

1: No juicy texture

### Presence of Residual Red Meat Portion

5: No red meat portion is present, and the blood has been entirely browned.

4: The red met portion occupies about 1/9 of the cut surface.

3: The red met portion occupies about ⅛ of the cut surface.

2: The red met portion occupies about 1/7 of the cut surface.

1: The red met portion occupies about ⅙ of the cut surface.

In the reference test, deep-frying and tempering were performed twice and once, respectively, as indicated in Table 1 below. On the other hand, in Test Sections 1 to 20, deep-frying and tempering were performed three times and twice, respectively, as indicated in Tables 2 to 8.

TABLE 1

| | Reference Example 1 | | |
|---|---|---|---|
| | Deep-frying | | Central |
| | temperature | Deep-frying | temperature |
| | (° C.) | time | (° C.) |
| Before deep-frying | — | — | 6-8 |
| First deep-frying | 170 | 1:20 | 75 |
| First tempering | — | 3:00 | — |
| Second deep-frying | 170 | 2:10 | 78 |

| | |
|---|---|
| Second tempering | — |
| Third deep-frying | — |
| Average mass (g) per | 40 |
| piece of food material | |
| Average mass (g) per | 34 |
| piece after deep-frying | |
| Yield rate (%) | 84.6 |
| Juicy texture (score) | 3 |
| Presence of residual | 2 |
| red meat (score) | |

TABLE 2

| | Test Section 1 | | | Test Section 2 | | | Test Section 3 | | |
|---|---|---|---|---|---|---|---|---|---|
| | Deep-frying | | Central | Deep-frying | | Central | Deep-frying | | Central |
| | temperature | Deep-frying | temperature | temperature | Deep-frying | temperature | temperature | Deep-frying | temperature |
| | (° C.) | time | (° C.) | (° C.) | time | (° C.) | (° C.) | time | (° C.) |
| Before | — | — | 6-8 | — | — | 6-8 | — | — | 6-8 |
| deep-frying | | | | | | | | | |
| First | 170 | 0:40 | — | 160 | 0:40 | — | 155 | 0:40 | — |
| deep-frying | | | | | | | | | |
| First tempering | — | 2:30 | — | | 2:30 | — | | 2:30 | — |
| Second | 170 | 1:30 | — | 160 | 1:40 | — | 170 | 1:30 | — |
| deep-frying | | | | | | | | | |
| Second | — | 2:30 | — | | 2:30 | — | | 2:30 | — |
| tempering | | | | | | | | | |
| Third | 170 | 1:20 | 78-82 | 160 | 1:30 | 80-81 | 170 | 1:20 | 77-78 |
| deep-frying | | | | | | | | | |

| | | | |
|---|---|---|---|
| Average mass | 43 | 40 | 43 |
| (g) per piece of | | | |
| food material | | | |
| Average mass | 36 | 36 | 38 |
| (g) per piece | | | |
| after | | | |
| deep-frying | | | |
| Yield rate (%) | 85.2 | 90.9 | 88.3 |
| Juicy texture | 4 | 5 | 5 |
| (score) | | | |
| Presence of | 5 | 5 | 5 |
| residual red | | | |
| meat (score) | | | |

TABLE 3

| | Test Section 4 | | | Test Section 5 | | | Test Section 6 | | |
|---|---|---|---|---|---|---|---|---|---|
| | Deep-frying | | Central | Deep-frying | | Central | Deep-frying | | Central |
| | temperature | Deep-frying | temperature | temperature | Deep-frying | temperature | temperature | Deep-frying | temperature |
| | (° C.) | time | (° C.) | (° C.) | time | (° C.) | (° C.) | time | (° C.) |
| Before | — | — | 6-8 | — | — | 6-8 | — | — | 6-8 |
| deep-frying | | | | | | | | | |
| First | 160 | 0:40 | — | 170 | 0:40 | — | 155 | 0:40 | — |
| deep-frying | | | | | | | | | |
| First tempering | | 2:30 | — | | 2:30 | — | | 2:30 | — |
| Second | 155 | 1:50 | — | 170 | 1:50 | — | 155 | 1:40 | — |
| deep-frying | | | | | | | | | |
| Second | | 2:30 | — | | 2:30 | — | | 2:30 | — |
| tempering | | | | | | | | | |
| Third | 170 | 1:20 | 78-82 | 160 | 1:00 | 80-82 | 165 | 1:35 | 78-80 |
| deep-frying | | | | | | | | | |

| | | | |
|---|---|---|---|
| Average mass | 43 | 42 | 43 |
| (g) per piece of | | | |
| food material | | | |
| Average mass | 38 | 37 | 38 |
| (g) per piece | | | |
| after | | | |
| deep-frying | | | |
| Yield rate (%) | 89.8 | 89.6 | 88.1 |
| Juicy texture | 5 | 5 | 5 |
| (score) | | | |
| Presence of | 5 | 5 | 5 |
| residual red | | | |
| meat (score) | | | |

TABLE 4

| | Test Section 7 | | | Test Section 8 | | | Test Section 9 | | |
|---|---|---|---|---|---|---|---|---|---|
| | Deep-frying | | Central | Deep-frying | | Central | Deep-frying | | Central |
| | temperature | Deep-frying | temperature | temperature | Deep-frying | temperature | temperature | Deep-frying | temperature |
| | (° C.) | time | (° C.) | (° C.) | time | (° C.) | (° C.) | time | (° C.) |
| Before | — | — | 10.0 | — | — | 9.4 | — | — | 7.5 |
| deep-frying | | | | | | | | | |
| First | 170 | 1:20 | 40.0 | 170 | 1:20 | 46.2 | 170.0 | 1:20 | 37.3 |
| deep-frying | | | | | | | | | |
| First tempering | | 1:30 | 51.3 | | 1:30 | 55.8 | | 1:30 | 49.1 |
| Second | 170 | 1:20 | 74.0 | 150 | 1:20 | 69.9 | 130.0 | 1:20 | 63.0 |
| deep-frying | | | | | | | | | |
| Second | | 1:30 | 79.6 | | 1:30 | 78.1 | | 1:30 | 72.5 |
| tempering | | | | | | | | | |
| Third | 170 | 1:20 | 89.3 | 170 | 1:20 | 88.9 | 170.0 | 1:20 | 83.9 |
| deep-frying | | | | | | | | | |

| | | | |
|---|---|---|---|
| Average mass | 31.5 | 34.0 | 28.1 |
| (g) per piece of | | | |
| food material | | | |
| Average mass | 27.1 | 29.4 | 24.8 |
| (g) per piece | | | |
| after | | | |
| deep-frying | | | |
| Yield rate (%) | 86.0 | 86.5 | 88.2 |
| Juicy texture | 5 | 5 | 5 |
| (score) | | | |
| Presence of | 5 | 5 | 5 |
| residual red | | | |
| meat (score) | | | |

TABLE 5

| | Test Section 10 | | | Test Section 11 | | | Test Section 12 | | |
|---|---|---|---|---|---|---|---|---|---|
| | Deep-frying | | Central | Deep-frying | | Central | Deep-frying | | Central |
| | temperature | Deep-frying | temperature | temperature | Deep-frying | temperature | temperature | Deep-frying | temperature |
| | (° C.) | time | (° C.) | (° C.) | time | (° C.) | (° C.) | time | (° C.) |
| Before | — | — | | — | — | 8.4 | — | — | 9.8 |
| deep-frying | | | | | | | | | |
| First | 150 | 1:20 | 40.0 | 130 | 1:20 | 38.7 | 130 | 1:20 | 38.7 |
| deep-frying | | | | | | | | | |
| First tempering | | 1:30 | 49.2 | | 1:30 | 49.9 | | 1:30 | 46.7 |
| Second | 130 | 1:20 | 68.2 | 150 | 1:20 | 64.6 | 130 | 1:20 | 62.7 |
| deep-frying | | | | | | | | | |
| Second | | 1:30 | 69.3 | | 1:30 | 72.3 | | 1:30 | 67.9 |
| tempering | | | | | | | | | |
| Third | 170 | 1:20 | 83.1 | 170 | 1:20 | 82.2 | 170 | 1:20 | 82.3 |
| deep-frying | | | | | | | | | |

| | | | |
|---|---|---|---|
| Average mass | 33.1 | 31.8 | 31.1 |
| (g) per piece of | | | |
| food material | | | |
| Average mass | 29.2 | 29.1 | 30.9 |
| (g) per piece | | | |
| after | | | |
| deep-frying | | | |
| Yield rate (%) | 88.3 | 91.4 | 99.2 |
| Juicy texture | 5 | 5 | 5 |
| (score) | | | |
| Presence of | 5 | 5 | 5 |
| residual red | | | |
| meat (score) | | | |

TABLE 6

| | Test Section 13 | | | Test Section 14 | | | Test Section 15 | | |
|---|---|---|---|---|---|---|---|---|---|
| | Deep-frying | | Central | Deep-frying | | Central | Deep-frying | | Central |
| | temperature | Deep-frying | temperature | temperature | Deep-frying | temperature | temperature | Deep-frying | temperature |
| | (° C.) | time | (° C.) | (° C.) | time | (° C.) | (° C.) | time | (° C.) |
| Before | — | — | 6.8 | — | — | 8.0 | — | — | 9.0 |
| deep-frying | | | | | | | | | |
| First | 170 | 1:20 | 32.3 | 170 | 1:20 | 44.9 | 170 | 1:00 | 39.5 |
| deep-frying | | | | | | | | | |
| First tempering | | 3:00 | 48.0 | | 3:00 | 55.5 | | 1:30 | 43.4 |
| Second | 130 | 1:20 | 64.3 | 130 | 1:20 | 59.1 | 150 | 1:00 | 72.8 |
| deep-frying | | | | | | | | | |
| Second | | 3:00 | 72.9 | | 3:00 | 72.7 | | 1:30 | 73.6 |
| tempering | | | | | | | | | |
| Third | 170 | 1:20 | 85.2 | 170 | 1:20 | 79.8 | 170 | 1:00 | 79.3 |
| deep-frying | | | | | | | | | |

| | | | |
|---|---|---|---|
| Average mass | 31.0 | 35.1 | 33.4 |
| (g) per piece of | | | |
| food material | | | |
| Average mass | 27.4 | 31.0 | 30.3 |
| (g) per piece | | | |
| after | | | |
| deep-frying | | | |
| Yield rate (%) | 88.2 | 88.1 | 90.7 |
| Juicy texture | 5 | 5 | 5 |
| (score) | | | |
| Presence of | 5 | 5 | 5 |
| residual red | | | |
| meat (score) | | | |

TABLE 7

| | Test Section 16 | | | Test Section 17 | | | Test Section 18 | | |
|---|---|---|---|---|---|---|---|---|---|
| | Deep-frying | | Central | Deep-frying | | Central | Deep-frying | | Central |
| | temperature | Deep-frying | temperature | temperature | Deep-frying | temperature | temperature | Deep-frying | temperature |
| | (° C.) | time | (° C.) | (° C.) | time | (° C.) | (° C.) | time | (° C.) |
| Before | — | — | 8.0 | — | — | 9.0 | — | — | 11.4 |
| deep-frying | | | | | | | | | |
| First | 170 | 0:50 | 24.5 | 170 | 0:50 | 21.5 | 170 | 1:00 | 34.2 |
| deep-frying | | | | | | | | | |
| First tempering | | 1:30 | 31.4 | | 2:30 | 39.4 | | 2:30 | 55.4 |
| Second | 170 | 0:50 | 47.7 | 150 | 0:50 | 54.7 | 150 | 1:00 | 64.5 |
| deep-frying | | | | | | | | | |
| Second | | 1:30 | 59.0 | | 2:30 | 65.8 | | 2:30 | 73.8 |
| tempering | | | | | | | | | |
| Third | 170 | 0:50 | 65.7 | 150 | 0:50 | 71.6 | 150 | 1:00 | 76.0 |
| deep-frying | | | | | | | | | |

| | | | |
|---|---|---|---|
| Average mass | 33.9 | 36.9 | 34.2 |
| (g) per piece of | | | |
| food material | | | |
| Average mass | 31.6 | 34.0 | 31.6 |
| (g) per piece | | | |
| after | | | |
| deep-frying | | | |
| Yield rate (%) | 93.2 | 92.1 | 92.5 |
| Juicy texture | 5 | 5 | 5 |
| (score) | | | |
| Presence of | 5 | 5 | 5 |
| residual red | | | |
| meat (score) | | | |

TABLE 8

| | Test Section 19 | | | Test Section 20 | | | Test Section 21 | | |
|---|---|---|---|---|---|---|---|---|---|
| | Deep-frying | | Central | Deep-frying | | Central | Deep-frying | | Central |
| | temperature | Deep-frying | temperature | temperature | Deep-frying | temperature | temperature | Deep-frying | temperature |
| | (° C.) | time | (° C.) | (° C.) | time | (° C.) | (° C.) | time | (° C.) |
| Before | — | — | 20.8 | — | — | 21.4 | — | — | 20.9 |
| deep-frying | | | | | | | | | |
| First | 170 | 0:50 | 32.0 | 170 | 0:50 | 37.7 | 170 | 1:20 | 45.2 |
| deep-frying | | | | | | | | | |
| First tempering | | 2:30 | 51.7 | | 2:30 | 51.2 | | 2:30 | 60.9 |
| Second | 170 | 0:50 | 63.0 | 170 | 0:50 | 60.7 | 150 | 1:20 | 73.7 |
| deep-frying | | | | | | | | | |
| Second | | 2:30 | 72.3 | | 2:30 | 69.4 | | 2:30 | 78.5 |
| tempering | | | | | | | | | |
| Third | 170 | 0:50 | 78.4 | 170 | 0:50 | 80.3 | 150 | 0:40 | 82.6 |
| deep-frying | | | | | | | | | |

| | | | |
|---|---|---|---|
| Average mass | 29.3 | 34.0 | 34.8 |
| (g) per piece of | | | |
| food material | | | |
| Average mass | 26.5 | 31.3 | 30.7 |
| (g) per piece | | | |
| after | | | |
| deep-frying | | | |
| Yield rate (%) | 90.7 | 92.0 | 88.3 |
| Juicy texture | 5 | 5 | 5 |
| (score) | | | |
| Presence of | 5 | 5 | 5 |
| residual red | | | |
| meat (score) | | | |

When Reference Example 1 (two deep-frying operations and one tempering operation) and Test Sections 1 to 21 (three deep-frying operations and two tempering operations) were compared with each other, Test Sections 1 to 21 were improved more in terms of the yield rate. Also in terms of the juicy texture and the presence of residual red meat, the scores of Test Sections 1 to 21 were better than those of the reference section.

### Test Example 2

A test sample obtained by coating an ingredient (chicken meat; average mass per piece: 32 g) with batter (average mass per piece: 6 g) by a conventional method was subjected to repeated deep-frying and tempering operations using a plurality of deep-frying units (oil tanks—6 kg of an oil). In Reference Example 2, deep-frying and tempering were performed twice and once, respectively, as indicated in Table 9. Also, in Test Section 22, deep-frying and tempering were performed three times and twice, respectively, as indicated in Table 10. In both of Reference Example 2 and Test Section 22, the test conditions were set so that the central temperature of the sample after the deep-frying was retained at about 70° C. for 1 minute or more. Also, the total amount (kg) of the oil reduced in each of the deep-frying units was measured as the total amount of the oil absorbed by each of the samples.

TABLE 9

| | Reference Example 2 | |
|---|---|---|
| | Deep-frying temperature (° C.) | Deep-frying time |
| First deep-frying | 175 | 1:20 |
| First tempering | — | 3:00 |
| Second deep-frying | 175 | 2:10 |

TABLE 10

| | Test Section 22 | |
|---|---|---|
| | Deep-frying temperature (° C.) | Deep-frying time |
| First deep-frying | 165 | 0:40 |
| First tempering | — | 2:30 |
| Second deep-frying | 155 | 1:10 |
| Second tempering | — | 2:30 |
| Third deep-frying | 165 | 1:30 |

The results were as indicated in Tables 11 and 12. Here, the total throughput means the total amount (kg) of the ingredient used in the deep-fried sample, which is an index of the total amount of the produced deep-fried food.

TABLE 11

| | Reference Example 2 | | | |
|---|---|---|---|---|
| Total | First | Second | Total | Amount (kg) |
| throughput | deep-drying | deep-drying | amount of | of oil |
| (kg) | unit (kg) | unit (kg) | oil (kg) | absorbed |
| 0.0 | 6.00 | 6.00 | 12.00 | 0.00 |
| 8.5 | 4.20 | 4.90 | 9.10 | 2.90 |
| 13.3 | 3.75 | 4.87 | 8.62 | 3.38 |

TABLE 12

| | Reference Example 2 | | | | |
|---|---|---|---|---|---|
| Total | First | Second | Third | Total | Amount (kg) |
| throughput | deep-drying | deep-drying | deep-drying | amount of | of oil |
| (kg) | unit (kg) | unit (kg) | unit (kg) | oil (kg) | absorbed |
| 0.0 | 6.00 | 6.00 | 6.00 | 18.00 | 0.00 |
| 8.8 | 4.89 | 5.92 | 6.01 | 16.82 | 1.18 |
| 15.5 | 4.40 | 5.94 | 6.10 | 16.44 | 1.56 |
| 20.6 | 4.03 | 5.89 | 6.20 | 16.12 | 1.88 |
| 21.9 | 3.93 | 5.89 | 6.20 | 16.02 | 1.98 |
| 28.0 | 3.53 | 5.86 | 6.33 | 15.71 | 2.29 |

In Reference Example 2 (two deep-frying operations and one tempering operation), the amount of the oil absorbed was 3.38 kg at the time point when the total throughput arrived at 13.3 kg. On the other hand, in Test Section 22 (three deep-frying operations and two tempering operations), the amount of the oil absorbed was 2.29 kg at the time point when the total throughput arrived at 28.0 kg. In other words, in Test Section 22, even when the total throughput of the sample was at least twice as large as that in Reference Example 2, the amount of the oil absorbed was smaller than that in Reference Example 2, and the amount of the oil reduced in each of the deep-frying units was also smaller.

Also, the results of Reference Example 2 and Test Section 22 were compared in terms of trend by linear approximation (Excel 2016), The results were as shown in FIG. 4. Also in FIG. 4, it was confirmed that the amount of the oil absorbed per total throughput was significantly small in Test Section 22, as compared with that in Reference Example 2.

From these results, it can be seen that three deep-frying operations and two tempering operations can greatly save the amount of the oil used, as compared with two deep-frying operations and one tempering operation.

### Test Example 3

According to a technique similar to that employed in Test Example 2, a test sample obtained by coating an ingredient (chicken meat; average mass per piece: 32 g) with batter (average mass per piece: 6 g) by a conventional method was subjected to repeated deep-frying and tempering operations using a plurality of deep-frying units (oil tanks—6 kg of an oil). In Reference Examples 3A to 3C (n=3 for each of the reference examples, and total throughput: 0.1 kg), deep-frying and tempering were performed twice and once, respectively, according to the indication in Table 13. In Test Sections 23A to 23C (n=3 for each of the test sections, and total throughput: 0.1 kg), deep-frying and tempering were performed three times and twice, respectively, according to the indication in Table 14.

TABLE 13

| | Reference Examples 3A to 3C | |
|---|---|---|
| | Deep-frying temperature (° C.) | Deep-frying time |
| First deep-frying | 171 | 1:20 |
| First tempering | — | 3:00 |
| Second deep-frying | 172 | 2:10 |

TABLE 14

| | Reference Examples 3A to 3C | |
|---|---|---|
| | Deep-frying temperature (° C.) | Deep-frying time |
| First deep-frying | 165 | 0:40 |
| First tempering | — | 2:30 |
| Second deep-frying | 150 | 1:10 |
| Second tempering | — | 2:30 |
| Third deep-frying | 165 | 1:25 |

The resultant deep-fried sample was stored at −35° C. to −40° C. for 1 hour or more to obtain a frozen sample. Next, the frozen sample was thawed in a microwave oven (600 W, 120 seconds), and then allowed to stand for 2 minutes. The coating of the resultant sample was peeled off with tweezers to separate the coating and the ingredient from each other. The coating and ingredient were crushed with a mill to measure the amount of moisture contained in the ingredient and the amount of the oil absorbed by the coating. Note that the amount (% by mass) of moisture contained in the ingredient was measured using a SMART6™ moisture/solid content meter (OEM), and that the amount (% by mass) of the oil absorbed by the coating was measured an ORACLE fat content analyzer (CEM.

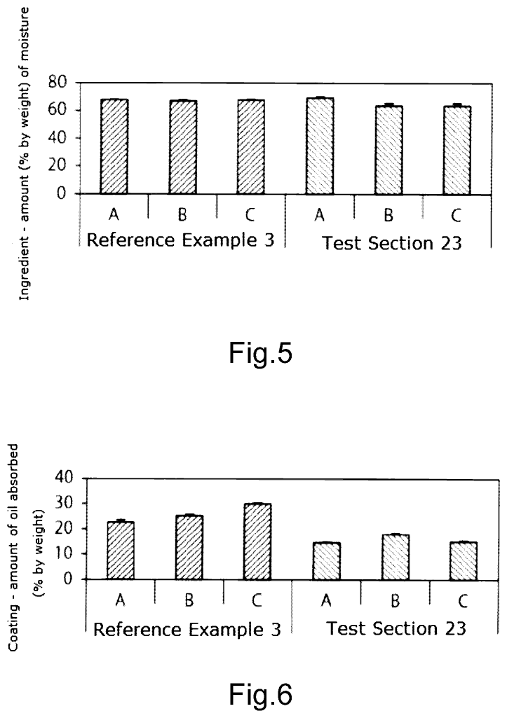

The results regarding the amount of moisture contained in the ingredient was as shown in FIG. 5. The amounts of moisture contained in the ingredients in Test Sections 23A to 23C were not confirmed to be significantly different from those in Reference Examples 3A to 3C, From this result, it was confirmed that, in Test Sections 23A to 23C (three deep-frying operations and two tempering operations), the amounts of moisture retained in the ingredients were equivalent to those in Reference Examples 3A to 3C (two deep-frying operations and one tempering operation), despite a larger number of times of deep-frying treatment.

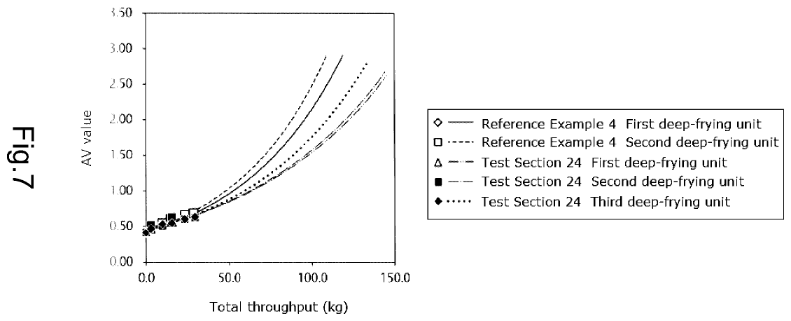

The results regarding the amount of the oil absorbed by the coating were as shown in FIG. 6. It was confirmed that the amounts of the oil absorbed in Test Sections 23A to 23C were significantly lower than those in Reference Examples 3A to 3C (the p value between the factors in the two-way analysis of variance was p <0.01). From this result, it was confirmed that, in Test Sections 23A to 23C (three deep-frying operations and two tempering operations), the amounts of the oil absorbed by the coating were smaller than those in Reference Examples 3A to 3C (two deep-frying operations and one tempering operation), despite a larger number of times of deep-frying treatment.

### Test Example 4

An ingredient (chicken meat; average mass per piece: 32 g) was directly used as a test sample without being coated with batter, and subjected to repeated deep-frying and tempering operations using a plurality of deep-frying units (oil tanks—6 kg of an oil). This deep-frying test was conducted on five days, in total, in one week.

In Reference Example 4, deep-frying and tempering were performed twice and once, respectively, as indicated in Table 15. Also, in Test Section 24 deep-frying and tempering were performed three times and twice, respectively, as indicated in Table 16. In both of Reference Example 4 and Test Section 24, the test conditions were set so that the central temperature of the sample after the deep-frying was retained at about 70° C. for 1 minute or more.

TABLE 15

| | Reference Example 4 | |
|---|---|---|
| | Deep-frying temperature (° C.) | Deep-frying time |
| First deep-frying | 175 | 1:20 |
| First tempering | — | 3:00 |
| Second deep-frying | 175 | 2:10 |

TABLE 16

| | Test Section 24 | |
|---|---|---|
| | Deep-frying temperature (° C.) | Deep-frying time |
| First deep-frying | 165 | 0:40 |
| First tempering | — | 2:30 |
| Second deep-frying | 155 | 1:10 |
| Second tempering | — | 2:30 |
| Third deep-frying | 165 | 1:30 |

Also, in both of Reference Example 4 and Test Section 24 the total throughput (g) of the sample (ingredient) and the total heating time (total deep-frying time) were set as follows.

TABLE 17

| Test Day | Total throughput (g) | Total warming time |
|---|---|---|
| Day 1 | 5329 | 2 hours 25 minutes |
| Day 2 | 11223 | 4 hours 12 minutes |
| Day 3 | 8841 | 4 hours 25 minutes |
| Day 4 | 11981 | 4 hours 45 minutes |
| Day 5 | 9591 | 4 hours 25 minutes |

In each of the deep-frying units, the oil acid value (AV value) was measured with an oil acid value meter (Model DOM-24, manufactured by ATGO CO., LTD.) while the oil (24° C. to 26° C.) before warming on each test day was stirred.

The results of Reference Example 4 and Test Section 24 were compared in terms of trend by exponential approximation (Excel 2016). The results were as shown in FIG. 7.

From the results shown in FIG. 7, it was confirmed that the difference in AV value between Reference Example 4 and Test Section 24 became larger as the total throughput increased, and that the deterioration of the oil in Test Section 24 (three deep-frying operations and two tempering operations) was suppressed more than that in Reference Example 4 (two deep-frying operations and one tempering operation).

### REFERENCE SIGNS LIST

1. Deep-frying apparatus
2. First deep-frying unit
3. First conveying unit
4. Second deep-frying unit
5. Second conveying unit
6. Third deep-frying unit

1. A method for producing a deep-fried food, comprising:
a first step of deep-frying a food material to obtain a first deep-fried material, and tempering the first deep-fried material in a state of being taken out from an oil;
a second step of deep-frying the first deep-fried material to obtain a second deep-fried material, and tempering the second deep-fried material in a state of being taken out from an oil; and
a third step of deep-frying the second deep-fried material to obtain a deep-fried food from an oil,
wherein a mass proportion of the deep-fried food to the food material is 85% or more.

2. A method for reducing the amount of an oil to be absorbed by a food material in the production of a deep-fried food, comprising:
a first step of deep-frying a food material to obtain a first deep-fried material, and tempering the first deep-fried material in a state of being taken out from an oil;
a second step of deep-frying the first deep-fried material to obtain a second deep-fried material, and tempering the second deep-fried material in a state of being taken out from an oil; and
a third step of deep-frying the second deep-fried material to obtain a deep-fried food from an oil.

3. The method according to claim 1, wherein the food material comprises a livestock or marine product, a vegetable, or a processed product thereof.

4. The method according to claim 1, wherein the deep-frying in the first step is performed at a low, medium or high temperature.

5. The method according to claim 1, wherein the deep-frying time in the first step is 30 seconds or more and 3 minutes or less.

6. The method according to claim 1, wherein the tempering in the first step is performed at an ordinary temperature.

7. The method according to claim 1, wherein the tempering time in the first step is 30 seconds or more and 5 minutes or less.

8. The method according to claim 1, wherein the deep-frying in the second step is performed at a low, medium or high temperature.

9. The method according to claim 1, wherein the deep-frying time in the second step is 30 seconds or more and 3 minutes or less.

10. The method according to claim 1, wherein the tempering in the second step is performed at an ordinary temperature.

11. The method according to claim 1, wherein the tempering time in the second step is 30 seconds or more and 5 minutes or less.

12. The method according to claim 1, wherein the deep-frying in the third step is performed at a medium or high temperature.

13. The method according to claim 1, wherein the deep-frying time in the third step is 30 seconds or more and 3 minutes or less.

14. The method according to claim 1, wherein the time ranging from the beginning of the deep-frying in the first step to the obtainment of the deep-fried food in the third step is 5 minutes or more and 15 minutes or less.

15. A deep-fried food obtained by the method according to claim 1.

16. A method for improving a yield in a deep-fried food, comprising:
a first step of deep-frying a food material to obtain a first deep-fried material, and tempering the first deep-fried material in a state of being taken out from an oil;
a second step of deep-frying the first deep-fried material to obtain a second deep-fried material, and tempering the second deep-fried material in a state of being taken out from an oil; and
a third step of deep-frying the second deep-fried material to obtain a deep-fried food from an oil,
wherein a yield calculated as a mass proportion of the deep-fried food to the food material is 85% or more.

17. The method according to claim 16, which suppresses deterioration of an oil in the production of a deep-fried food with an improved yield.

18. An apparatus for producing a deep-fried food, comprising:
a first deep-frying unit for deep-frying a food material to obtain a first deep-fried material;
a second deep-frying unit for deep-frying the first deep-fried material to obtain a second deep-fried material;
a third deep-frying unit for deep-frying the second deep-fried material to obtain a deep-fried food;
a first conveying unit for conveying the first deep-fried material taken out from the first deep-frying unit to the second deep-frying unit while tempering it; and
a second conveying unit for conveying the second deep-fried material taken out from the second deep-frying unit to the third deep-frying unit while tempering it.

19. The method according to claim 2, wherein the food material comprises a livestock or marine product, a vegetable, or a processed product thereof.

20. The method according to claim 2, wherein the deep-frying in the first step is performed at a low, medium or high temperature.
